(19) United States
(12) Patent Application Publication
(10) Pub. No.: US 2021/0012459 A1
(43) Pub. Date: Jan. 14, 2021

(54) IMAGE PROCESSING METHOD AND APPARATUS

(71) Applicant: SZ DJI TECHNOLOGY CO., LTD., Shenzhen (CN)

(72) Inventors: Xing CHEN, Shenzhen (CN); Zisheng CAO, Shenzhen (CN); Wei TUO, Shenzhen (CN); Junping MA, Shenzhen (CN); Qiang ZHANG, Shenzhen (CN)

(21) Appl. No.: 17/031,475

(22) Filed: Sep. 24, 2020

Related U.S. Application Data
(63) Continuation of application No. PCT/CN2018/093522, filed on Jun. 29, 2018.

(51) Int. Cl. G06T 3/40; G06T 5/50

(52) U.S. Cl. CPC G06T 3/4007; G06T 2207/20016; G06T 2207/10024; G06T 5/50

(57) ABSTRACT

A method for image processing includes determining an upsample region based on a region excluding a region of interest in an image; and performing an upsampling operation in the upsample region without performing the upsampling operation in the region of interest.

### CROSS-REFERENCE TO RELATED APPLICATION

This application is a continuation of International Application No. PCT/CN2018/093522, filed Jun. 29, 2018, the entire content of which is incorporated herein by reference.

### TECHNICAL FIELD

The present disclosure relates to the field of image processing and, more particularly, to an image processing method and an image processing apparatus.

### BACKGROUND

A high-speed camera needs a high operation speed and a high resolution for taking high quality images. However, a bandwidth of a sensor component of the camera is usually limited. Therefore, high operation speed and high resolution often contradict each other. That is, when a desired image resolution is realized, a desired frame rate may not be obtained, and vice versa. Conventional image processing technologies are used to improve performance of an image photographing apparatus, such as a camera, to increase pixel numbers in an image. However, in conventional image processing technologies, sawtooth, blur, or the like often occurs in the image.

### SUMMARY

In accordance with the disclosure, there is provided a method for image processing. The method includes determining an upsample region based on a region excluding a region of interest in an image; and performing an upsampling operation in the upsample region without performing the upsampling operation in the region of interest.

Also in accordance with the disclosure, there is provided an image processing apparatus. The image processing apparatus includes a processor and a memory storing instructions. The instructions, when executed by the processor, cause the processor to determine an upsample region based on a region excluding a region of interest (ROI) in an image; and perform an upsampling operation in the upsample region without performing the upsampling operation in the ROI.

### BRIEF DESCRIPTION OF THE DRAWINGS

FIG. 1 illustrates a schematic diagram showing an exemplary application scenario of image processing according to various disclosed embodiments of the present disclosure.

FIG. 2 illustrates a flowchart of an exemplary image processing method according to various disclosed embodiments of the present disclosure.

FIG. 3 illustrates a flowchart of another exemplary image processing method according to various disclosed embodiments of the present disclosure.

FIG. 4A illustrates a schematic view of an exemplary upsample region according to various disclosed embodiments of the present disclosure.

FIG. 4B illustrates a schematic view of an exemplary target region according to various disclosed embodiments of the present disclosure.

FIG. 5 illustrates an exemplary image including an exemplary upsample region according to various disclosed embodiments of the present disclosure.

FIG. 6A illustrates an image after being processed by a conventional image processing method.

FIG. 6B illustrates an exemplary image after being processed by an exemplary image process method according to various disclosed embodiments of the present disclosure.

FIG. 7 illustrates a flowchart of another exemplary image processing method according to various disclosed embodiments of the present disclosure.

FIG. 8 illustrates a block diagram of an exemplary hardware configuration of an exemplary image processing apparatus according to various disclosed embodiments of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings, in which the same numeral refers to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Further, in the present disclosure, the disclosed embodiments and the features of the disclosed embodiments may be combined when there are no conflicts.

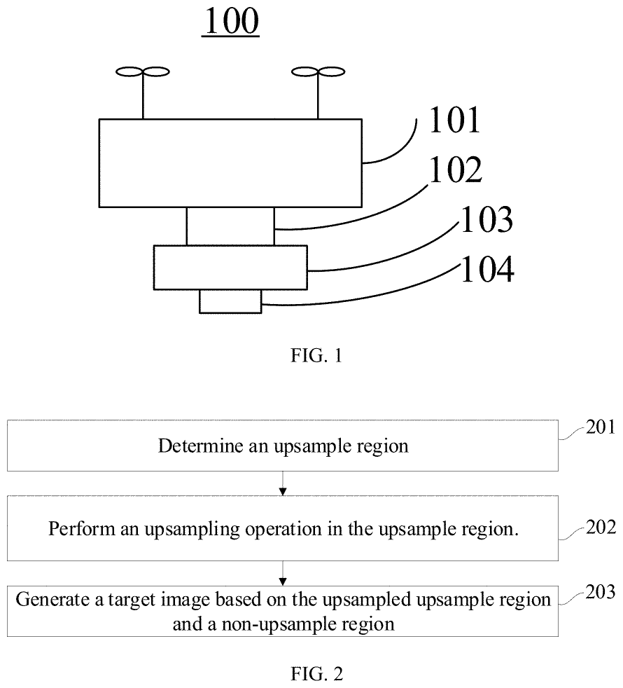

FIG. 1 illustrates a schematic diagram showing an exemplary application scenario of image processing according to various disclosed embodiments of the present disclosure. As shown in FIG. 1, a movable platform 100 includes a platform body 101, a gimbal 102, and a photographing apparatus 103. The gimbal 102 couples the photographing apparatus 103 to the platform body 101. The movable platform 100 further includes an image processing apparatus 104 coupled to the photographing apparatus 103. The image processing apparatus 104 may communicate with the photographing apparatus 103 through a wired connection and/or a wireless connection. In some embodiments, the photographing apparatus 103 may move together with the movable platform 100, and may capture images. The image processing apparatus 104 may receive images from the photographing apparatus 103, and may process the images.

In some embodiments, as described above and shown in FIG. 1, the platform body 101 carries the photographing apparatus 103 through the gimbal 102. In some other embodiments, the platform body 101 may carry the photographing apparatus 103 without the gimbal 102. That is, the photographing apparatus 103 may be directly attached to the movable platform 101.

In the example shown in FIG. 1, the image processing apparatus 104 is external to the photographing apparatus 103, i.e., the image processing apparatus 104 and the photographing apparatus 103 are separate apparatuses. In some embodiments, the image processing apparatus 104 may be attached to the photographing apparatus 103. In some other embodiments, the image processing apparatus 104 may be remote from the photographing apparatus 103. For example, the image processing apparatus 104 may be at a ground station or be a part of a remote controller, and can communicate with the image processing apparatus 103 through a wired or a wireless connection.

In some other embodiments, the image processing apparatus 104 may be part of the photographing apparatus 103, and can be, for example, a processor of the photographing apparatus 103.

In some other embodiments, the image processing apparatus 104 may be arranged in or on the platform body 101, and may be a part of a processing component of the movable platform 100.

In some embodiments, the movable platform 100 may include, for example, a manned vehicle or an unmanned vehicle. The unmanned vehicle may include a ground-based unmanned vehicle or an unmanned aerial vehicle (UAV).

In some embodiments, the photographing apparatus 103 may include a camera, a camcorder, or the like.

FIG. 2 illustrates a flowchart of an exemplary image processing method according to various disclosed embodiments of the present disclosure. The method can be implemented, for example, by the image processing apparatus 104 for processing an image acquired by the photographing apparatus 103. With reference to FIG. 2, the method is described below.

At 201, an upsample region of the image is determined.

The image may include at least one of a Bayer image or a red-green-blue (RGB) image. In a Bayer image, each pixel can record one of the three primary colors—red (R), green (G), and blue (B). Usually, approximately 50% of the pixels in the Bayer image are green, approximately 25% of the pixels are red, and approximately 25% of the pixels are blue. In an RGB image, each pixel may include three sub-pixels. The three sub-pixels correspond to red, green, and blue color components, respectively.

At 202, an upsampling operation is performed in the upsample region.

With the upsampling operation, the number of pixels, also referred to as a “pixel number,” is increased in the upsample region. The upsample region that has been subject to the upsampling operation may also be referred to as an “upsampled upsample region” or simply “upsampled region.”

At 203, a target image is generated based on the upsampled upsample region and a non-upsample region. The non-upsample region refers to a region where no upsampling operation is performed, and hence the number of pixels in the non-upsample region remains unchanged.

In some embodiments, the image processing method may further include outputting the target image.

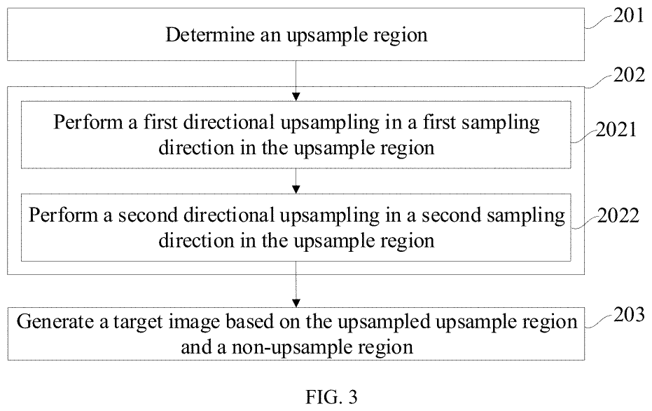

FIG. 3 illustrates a flowchart of another exemplary image processing method according to various disclosed embodiments of the present disclosure. The processes 201 and 203 in FIG. 3 are same as or similar to processes 201 and 203 described above in connection with FIG. 2. Further, as shown in FIG. 3, performing the upsampling operation in the upsample region (202) includes performing a first directional upsampling in a first sampling direction in the upsample region (2021), and performing a second directional upsampling in a second sampling direction in the upsample region (2022).

In some embodiments, the first sampling direction may be a horizontal direction, and the second sampling direction may be a vertical direction. Correspondingly, the first directional upsampling may include upsampling in the horizontal direction, and the second directional upsampling may include upsampling in the vertical direction.

In some other embodiments, the first sampling direction may be a vertical direction, and the second sampling direction may be a horizontal direction. Correspondingly, the first directional upsampling may include upsampling in the vertical direction, and the second directional upsampling may include upsampling in the horizontal direction.

For example, performing a directional upsampling in a sampling direction such as the first sampling direction or the second sampling direction may include processes described below. A ratio of the number of pixels along the sampling direction in the upsample region to the number of target pixels along the sampling direction in a target region in a target image may be determined. The target region is a region corresponding to the upsample region. After pixel information such as pixel coordinates and pixel values of pixels in the target region are determined, the target region is then an upsampled upsample region. A pixel in the target region can also be referred to as a “target pixel.” As the target region corresponds to the upsample region, each of the target pixels in the target region can have a coordinate in the target region and corresponds to a coordinate in the upsample region. The corresponding coordinate in the upsample region is referred to as a “reversely-mapped coordinate” of the target pixel. A reversely-mapped coordinate in the upsample region may be determined according to the ratio and the coordinate of the target pixel in the target region. That is, the reversely-mapped coordinate may be obtained by multiplying the coordinate of the target pixel by the ratio.

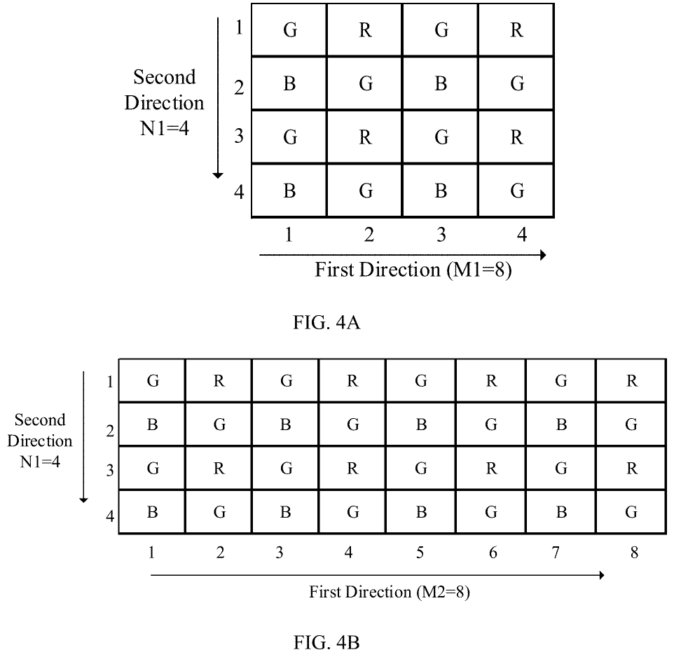

For example, FIG. 4A shows an upsample region including M1*N1 pixels, where there are M1 pixels in a first direction, and N1 pixels in a second direction. For illustrative purposes, FIG. 4A shows an example in which M1=4 and N1=4. Further, FIG. 4B shows a target region after a first direction upsampling. The target region includes M2*N1 pixels and, in the example shown in FIG. 4B, M2=8. The ratio of the number of pixels along the sampling direction in the upsample region to the number of target pixels along the sampling direction in a target region in a target image can be determined, which is M1/M2=0.5 in the example shown in FIGS. 4A and 4B. For a target pixel having a coordinate of (C1,C2) in the target region, the corresponding reversely-mapped coordinate of the target pixel is (C1*M1/M2,C2). For example, for the target pixel at the most upper right corner of the target region, (C1,C2)=(8,1). The corresponding reversely-mapped coordinate of the target pixel is (C1*M1/M2,C2)=(8*0.5,1)=(4,1), which is at the most upper right corner of the upsample region. The reversely-mapped coordinate of the target pixel may include an integer or a non-integer. As described above, the reversely-mapped coordinate of (4,1) includes an integer. For another target pixel (C1,C2)=(7,1), the corresponding reversely-mapped coordinate is (3.5,1) and hence includes a non-integer.

In FIGS. 4A and 4B, the first direction points to the right, and the second direction points down, which are merely for illustrative purposes and are not intended to limit the scope of the present disclosure. For example, in some embodiments, the first direction may point to the left, and/or the second direction may point up.

Further, one or more pixels in the upsample region that are neighboring to and/or at the reversely-mapped coordinate of the target pixel and have a same color as the target pixel may be chosen according to the reversely-mapped coordinate of the target pixel. In this disclosure, the term “neighboring” does not necessarily require bordering. For example, a pixel neighboring to the reversely-mapped coordinate of the target pixel can be next to the reversely-mapped coordinate or be separated from the reversely-mapped coordinate by one or more, such as one to three, pixels. Further, in this disclosure, a pixel neighboring to or at the reversely-mapped coordinate of the target pixel may also be referred to as a pixel “near to” the reversely-mapped coordinate of the target pixel. A chosen pixel in the upsample region that is neighboring to or at the reversely-mapped coordinate of the target pixel and has a same color as the target pixel can also be referred to as a “near same-color pixel.”

Even if a pixel in the upsample region is at the reversely-mapped coordinate of the target pixel, the pixel in the upsample region may or may not have a same color as the target pixel. Still taking the upsample region and the target region in FIGS. 4A and FIG. 4B as an example, pixel (8,1) in the target region is a red (R) pixel. The corresponding “reversely-mapped coordinate” of the target pixel (8,1) is (4,1) in the upsample region, and (4,1) in the upsample region corresponds to a red pixel (R) having a same color as the target pixel. As an example, red pixel (4,1) in the upsample region may be chosen for determining the pixel value of the target pixel (8,1). As another example, red pixels near to the pixel (4,1) in the upsample region, such as pixels (2,1) and (4,1) in the upsample region, may be chosen for determining the pixel value of the target pixel (8,1).

However, for another target pixel (6,1) that is a R pixel, the corresponding “reversely-mapped coordinate” of the target pixel (6,1) is (3,1) in the upsample region, and (3,1) in the upsample region corresponds to a G pixel having a different color than the target pixel. Instead of pixel (3,1) in the upsample region, one or more red pixels near to the (3,1) in the upsample region may be chosen for determining the pixel value of the target pixel (6,1). For example, red pixel (2,1) or (4,1) that is near to pixel (3,1) in the upsample region may be chosen. As another example, both red pixels (2,1) and (4,1) may be chosen. The number of the one or more near same-color pixels corresponding to different target pixels may be same or different according to various application scenarios. For example, the number of the one or more near same-color pixels corresponding to a target pixel may be 1, the number of the one or more near same-color pixels corresponding to another target pixel may also be 1 or may be a different number such as 4.

For example, in a Bayer image, the color of a target pixel may be indicated by the remainder of the coordinate of the target pixel in one direction divided by 2, as there are only two colors in one row of a Bayer image. For example, for the 8 target pixels in the first row of the target region in FIG. 4B, corresponding remainders for red pixels are all 0, and corresponding remainders for green pixels are all 1. For red target pixel (8,1) in the target region, the corresponding remainder=8%2=0. For green target pixel (5,1) in the target region, the corresponding remainder=5%2=1. Similarly, the color of a pixel in the upsample region may be indicated by the remainder of the coordinate in one direction divided by 2. For example, for the 4 pixels in the first row of the upsample region in FIG. 4A, corresponding remainders for red pixels are all 0, corresponding remainders for green pixels are all 1. Thus, in the first row of the target region and the first row of the upsample region, a remainder of 0 indicates that the corresponding pixel is a red pixel, and a remainder of 1 indicates that the corresponding pixel is a green pixel.

As another example, the color of a pixel such as a target pixel or a pixel in the upsample region may be indicated by a number obtained by adding 1 to or subtracting 1 from the remainder of the coordinate of the pixel in one direction divided by 2 and. The number is also referred to as a “modified number.”

Further, the remainder and the modified number may be used as numbers, referred to as color-indication numbers, for indicating pixel colors. For example, in the target region, for rows 1 and 3, the remainder may be chosen as the color-indication number, and for row 2 and 4, modified number that equals to a remainder plus 1 may be chosen as the color-indication number. Accordingly, in the target region, the color-indication number of red target pixel (8,1) is 8/2=0, the color-indication number of green target pixel (6,1)=1; and the color-indication number of blue target pixel (5,2) is 5/2+1=2, the color-indication number of green target pixel (4,2)=4/2+1=1. In the target region, the color-indication number of each red target pixel is 0, the color-indication number of each green target pixel is 1, and the color-indication number of each blue target pixel is 2. Thus, in the target region, a color-indication numbers 0, 1, or 2 can be used to indicate a red target pixel, a green target pixel, or a blue target pixel, respectively. In the upsample region, for rows 1 and 3, the remainder may be chosen as the color-indication number, and for row 2 and 4, modified number that equals to a remainder plus 1 may be chosen as the color-indication number. Accordingly, in the upsample region, a color-indication numbers 0, 1 or 2 can be used to indicate a red pixel, a green pixel, or a blue pixel in the upsample region, respectively. References can be made to the above-descriptions.

Thus, it may be determined whether a target pixel in the target region has a same color as a pixel in the upsample region by determining whether a color-indication number of the target pixel is equal to a color-indication number of the pixel in the upsample region. If the color-indication number of the target pixel is equal to the color-indication number of the pixel in the upsample region, the target pixel in the target region may have a same color as the pixel in the upsample region. If the color-indication number of the target pixel is different from the color-indication number of the pixel in the upsample region, the target pixel in the target region may have a different color as compared to the pixel in the upsample region.

The above described approaches associated with the remainder of the coordinate of a pixel in one direction divided by 2 are merely for illustrative purposes and do not intend to limit the scope of the present disclosure. Other approaches may be chosen to indicate color of a pixel in the upsample region and/or color of a pixel in the target region according to various application scenarios.

Further, a pixel value of the target pixel may be determined according to the chosen one or more pixels in the upsample region. For example, the pixel value of the target pixel may be determined as being equal to the value of the pixel at the reversely-mapped coordinate of the target pixel and having a same color as the target pixel, referred to as an “equal-value approach”. As another example, the pixel value of the target pixel may be obtained by calculating an average of pixel values of pixels in the upsample region that are near to the reversely-mapped coordinate of the target pixel and have a same color as the target pixel, referred to as an “averaging approach.”

As another example, the pixel value of the target pixel may be obtained by calculating a weighted average of pixel values of pixels in the upsample region that are near to the reversely-mapped coordinate of the target pixel and have a same color as the target pixel, referred to as an “weighted averaging approach.” In the weighted averaging approach, the chosen pixels in the upsample region that are near to the reversely-mapped coordinate of the target pixel and have a same color as the target pixel may be denoted as Pmn, where m and n are positive integers, m=1, 2, 3, . . . , mₘₐₓ, and n=1, 2, 3, . . . , nₘₐₓ, and mₘₐₓ and nₘₐₓ are integers indicating maximum indices for the chosen pixels in the upsample region that are near to the reversely-mapped coordinate of the target pixel. A weighting factor for pixel Pmn is denoted as Wmn, which decreases as the distance between Pmn and the reversely-mapped coordinate increases. As such, a pixel value for pixel Pmn is Vmn, and thus the weighted average is equal to

$$\{ {Σ}_{\begin{matrix}1 \leq m \leq {m}_{max} \\ 1 \leq n \leq {n}_{max}\end{matrix}} ( Pmn * Wmn ) \} \text{/} \{ {Σ}_{\begin{matrix}1 \leq m \leq {m}_{max} \\ 1 \leq n \leq {n}_{max}\end{matrix}} ( Wmn ) \} .$$

It is noted that the indices, m and n, for the chosen pixels may or may not be the same as the indices for identifying a pixel. For example, a chosen pixel P21 may or may not be the pixel at (2,1) in the upsample region.

A pixel in the upsample region that is near to the reversely-mapped coordinate of the target pixel and have a same color as the target pixel may be located at left side, right side, upper side, lower side, upper-left side, upper-right side, lower-left side, or lower-right side of the reversely-mapped coordinate or at the reversely-mapped coordinate, or any combination thereof.

Further, the pixel value of the target pixel may be obtained by applying nearest neighbor interpolation filtering, bilinear interpolation filtering, or bicubic interpolation filtering to the one or more near same-color pixels in the upsample region.

In some embodiments, pixel values of all target pixels in a target region may be obtained by applying a same approach, such as one of the averaging approach, the weighted averaging approach, nearest neighbor interpolation filtering, bilinear interpolation filtering, or bicubic interpolation filtering. In some other embodiments, pixel values of different target pixels in the target region may be obtained by applying different approaches, such as different ones of the above-described approaches. For example, a pixel value of one target pixel in the target region may be obtained by using the equal-value approach, and a pixel value of anther pixel in the target region may be obtained by using another approach, such as the averaging approach.

In the nearest neighbor interpolation filtering, a pixel in the upsample region that is nearest to a reversely-mapped coordinate of a target pixel and has a same color as the target pixel may be determined, and can be referred to as a “nearest same-color pixel.” The pixel value of the target pixel may be obtained according to a pixel value of the nearest same-color pixel. For example, the pixel value of the target pixel may be equal to the pixel value of the nearest same-color pixel. For example, the nearest same-color pixel may be located at left side, right side, upper side, lower side, upper-left side, upper-right side, lower-left side, or lower-right side of the reversely-mapped coordinate. Consistent with the discussion above, in some embodiments, the nearest same-color pixel may be at the reversely-mapped coordinate.

As another example, in the bilinear interpolation filtering, a pixel value of a target pixel may be determined according to four pixels in the upsample region that surround the reversely-mapped coordinate (x0,y0) of the target pixel TP and have a same color as the target pixel. For example, the four pixels surrounding the reversely-mapped coordinate (x0,y0) may include pixel UP11 at coordinate (x1,y1), pixel UP12 at coordinate (x1,y2), pixel UP21 at coordinate (x2,y1), and pixel UP22 at coordinate (x2,y2). Further, v(UP11), v(UP12), v(UP21), and v(UP22) denote pixel values for pixels UP11, UP12, UP21, and UP22, respectively. To obtain a pixel value v(x0,y0) at the reversely-mapped coordinate (x0,y0), which equals the pixel value of the target pixel, a bilinear interpolation filtering may be performed by performing linear interpolation filtering in one direction, and then performing linear interpolation filtering in the other direction. The two directions may be perpendicular to each other. For example, a linear interpolation filtering on UP11 and UP21 in X direction may yield a pixel value

v(x0,y1)=({v(UP11)*(x2−x0)+v(UP21)*(x0−x1)})/(x2−x1)

at coordinate (x0,y1). Similarly, based on UP12 and UP22,

v(x0,y2)={v(UP12)*(x2−x0)+v(UP22)*(x0−x1)}/(x2−x1)

at coordinate (x0,y2) can be obtained. Further, based on v(x0,y1) and v(x0,y2), a linear interpolation filtering in Y direction may yield the pixel value

v(x0,y0)={v(x0,y1)*(y2−y0)+v(x0,y2)*(y0−y1)}/(y2−y1) at coordinate (x0,y0), which equals the pixel value of the target pixel.

In a bicubic interpolation filtering, a pixel value of a target pixel may be determined according to 16 data points, such as 16 pixels that surround the reversely-mapped coordinate (x0,y0) of the target pixel TP and have a same color as the target pixel. For example, the 16 pixels can include pixel UPmn at coordinate (xm,yn), where m=1, 2, 3, 4, n=1, 2, 3, 4, and v(UPmn) denotes a pixel value of pixel UPmn. (xm,yn) and v(UPmn) can be determined according to the reversely-mapped coordinate (x0,y0) of the target pixel TP. Through a cubic interpolation filtering on UP11, UP21, UP31 and UP41 in X direction, the coefficients a11, a21, a31, and a41 of a cubic function

f_y1(x)=a11*x\hat{ }3+a21*x\hat{ }2+a31*x+a41 (Function 1)

can be obtained. Further, the value f_y1(x0), i.e., pixel value v(x0,y1) at coordinate (x0,y1) can be obtained by plugging the values of x0, a11, a21, a31, and a41 into Function 1. Similarly, through a cubic interpolation filtering on UP12, UP22, UP32 and UP42, the coefficients a12, a22, a32, and a42 of a cubic function

f_y2(x)=a12*x\hat{ }3+a22*x\hat{ }2+a32*x+a42 (Function 2)

can be obtained. Thus, the value of f_y2(x), i.e., pixel value v(x0,y2) at coordinate (x0,y2) can be obtained by plugging the values of x, a12, a22, a32, and a42 into Function 2. Pixel value v(x0,y3) and pixel value v(x0,y4) can be obtained in a similar manner, a detailed description is omitted. Further, through a cubic interpolation filtering in Y direction based on v(x0,y1), v(x0,y2), v(x0,y3), and v(x0,y4), the coefficients a1, a2, a3, and a4 of a cubic function

f(y)=a1*y\hat{ }3+a2*y\hat{ }2+a3*y+a4 (Function 3)

can be obtained. Thus, the value of f(y), i.e., pixel value v(x0,y0) at the reversely-mapped coordinate (x0,y0), can be obtained by plugging the values of y0, a1, a2, a3, and a4 into Function 3.

In some embodiments, the upsample region described in process 201 may be determined based on a region excluding a region of interest (ROI) of the image. That is, the upsample region may not overlap the ROI, such as including, being part of, or partially overlapping the ROI. Correspondingly, the upsampling operation (at process 202) is performed in the upsample region without being performed in the ROI. The ROI may refer to a portion of the image that is of interest to a user, such as, for example, the portion of the image that contains information about an object that the user intends to study and/or is interested in. In some embodiments, the upsample region can be the entire region excluding the ROI of the image. In some other embodiments, the upsample region can be a portion of the region excluding the ROI of the image.

In the embodiments that the upsample region is determined as being in a region excluding the ROI of the image, the upsample region may not include the ROI, and the non-upsample region may include the ROI. In some embodiments, the non-upsample region may further include one or more regions that are outside the ROI but not included in the upsample region.

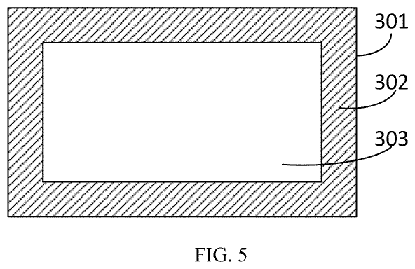

FIG. 5 illustrates an exemplary image including an exemplary upsample region according to various disclosed embodiments of the present disclosure. As shown in FIG. 5, an image 301 includes a border region 302 (the shaded region in the figure) including four border strips, which encloses a central region 303. The central regions can be considered as, for example, an ROI. The upsample region can be a region including the border region 302 or a region within the border region 302, such as a region within one or more of the four border strips.

In some embodiments, the entire border region 302 constitutes the upsample region. Correspondingly, the non-upsample region can be a region including the central region 303.

The ROI and the upsample region are not restricted to the above-described examples, and may be chosen according to various application scenarios.

For example, a central region in an image may be determined as an upsample region, and a border region of the image may be determined as an ROI. As another example, one of a left region or a right region of an image may be determined as an upsample region, and the other one of the left region or the right region of the image may be determined as an ROI. As another example, one of a top region or a bottom region of an image may be determined as an upsample region, and the other one of the top region or the bottom region of the image may be determined as an ROI.

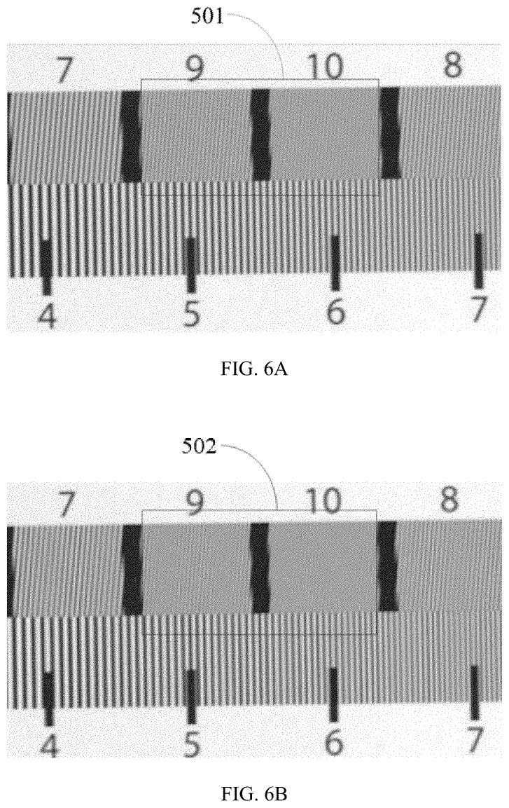

FIG. 6A illustrates an image after being processed using an image processing method consistent with the disclosure. FIG. 6B illustrates an image after being processed by using a conventional image process method. In the example shown in FIG. 6A, a region 501 is an ROI. The image shown in FIG. 6A is obtained by applying an upsampling operation in a determined upsample region that does not include the region 501, while the image shown in FIG. 6B is obtained by applying an upsampling operation to the entire image according to the conventional image processing method. A region 502 in FIG. 6B corresponds to the region 501 in FIG. 6A. The region 501 in the image of FIG. 6A has a better quality than the region 502 in the image of FIG. 6B. For example, strips in areas below 9 and 10 are of higher image quality in FIG. 6A than in FIG. 6B. As can be seen from FIGS. 6A and 6B, by using a method consistent with the disclosure to process an image, the resolution of the image can be changed without the image quality of certain region(s) in the image, such as the ROI, being affected.

In another examplary image processing method, a low-frequency region in an image may be determined as an upsample region. A low-frequency region refers to a region having image data that varies relatively slow, i.e., varies in a relatively large distance. A high-frequency region refers to a region having image data that varies relatively fast, i.e., varies in a relatively short distance. Image data varies slower, i.e., varies in a larger distance, in a low-frequency region than a high-frequency region. The image data refers to, for example, pixel values.

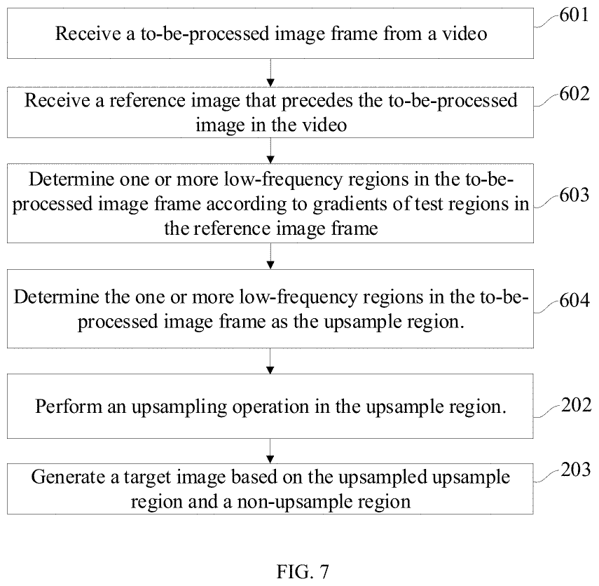

FIG. 7 illustrates a flowchart of another exemplary image processing method according to various disclosed embodiments of the present disclosure. With reference to FIG. 7, the method is described below.

At 601, a to-be-processed (TBP) image frame of a video is received. The video may be received from the photographing apparatus 103. A TBP image frame may include an image that need to be processed using, for example, an exemplary image processing method by the exemplary image processing apparatus 104.

At 602, a reference image frame of the video is received. The reference image frame may precede the TBP image frame in the video. For example, the reference image frame may be an image frame immediately before the TBP image frame in the sequence of image frames of the video. Accordingly, the reference image frame may have similarities with the TBP image frame, such as low-frequency region distributions. In some embodiments, the reference image frame may include one or more test regions. A test region refers to a region on which a frequency property is to be determined. The frequency property refers to whether a region is a low-frequency region or a high-frequency region.

At 603, one or more low-frequency regions in the TBP image frame may be determined according to gradients of test regions in the reference image frame.

In some embodiments, a gradient of each of the test regions in the reference image frame may be determined. Each test region may include one or more test sub-regions. In some embodiments, a test sub-region may have one of a rectangular shape or a circular shape. For each test region, gradients of the test sub-regions in that test region may be obtained and averaged to obtain the gradient of the test region.

In some embodiments, in the reference image frame, test regions that have gradients smaller than a preset value may be determined. Regions in the TBP image frame and corresponding to the test regions that have gradients smaller than the preset value may be determined as one or more low-frequency regions in the TBP image frame.

In some embodiments, the TBP image frame may include a first Bayer image, and the reference image frame may include a second Bayer image. In one embodiment, the gradient of the test sub-region may be obtained based on pixels of a same color in the test sub-region. The same color may be one of a red color, a green color, or a blue color. For example, the gradient of the test sub-region may be obtained based on pixels of red color in the test sub-region. In another embodiment, the gradient of the test sub-region may be obtained by calculating an average of gradients obtained based on pixels of two or more colors in the test sub-region, such as an average of a first gradient obtained based on pixels of a first color in the test sub-region, a second gradient obtained based on pixels of a second color in the test sub-region, and a third gradient obtained based on pixels of a third color in the test sub-region. For example, the first color may be red, the second color may be green, and the third color may be blue. Correspondingly, the first gradient, the second gradient, and the third gradient may be obtained, and further averaged to obtain the gradient of the test sub-region.

In some embodiments, the TBP image frame may include a first RGB image, and the reference image frame may include a second RGB image. The gradient of the test sub-region may be obtained based on pixels in the test sub-region. For example, a pixel value of each pixel may be calculated based on sub-pixels of the pixel, e.g., by averaging values of the sub-pixels in the pixel. Further, the gradient of the test sub-region may be obtained according to the calculated pixel value of each pixel.

At 604, the one or more low-frequency regions in the TBP image frame are determined as an upsample region. In some embodiments, the upsample region may have one of a parallelogram shape, a circular shape, a triangular shape, an irregular shape, or another suitable shape. Further, the parallelogram shape may include a square, a rectangle, or a rhombus.

Further, processes 202 and 203 are performed. Processes 202 and 203 are described above, descriptions of which are omitted here.

By determining one or more low-frequency regions in the TBP image as an upsample region and performing an upsampling operation in the upsample region, distortions in the image during upsampling may be suppressed, as compared to a conventional image processing method.

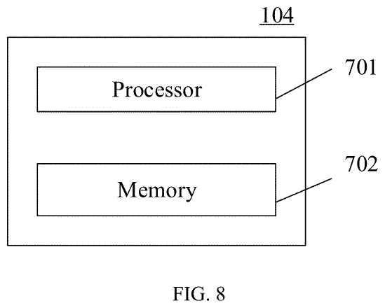

FIG. 8 illustrates a block diagram of an exemplary hardware configuration of an exemplary image processing apparatus 104 according to various disclosed embodiments of the present disclosure. As shown in FIG. 8, the data-processing apparatus 104 includes a processor 701 and a memory 702. The memory 702 stores instructions for execution by the processor 701 to perform a method consistent with the disclosure, such as one of the exemplary image processing methods described above. The image processing apparatus 104 may further include a data communication interface, to receive image frames or videos from the photographing apparatus 103.

In some embodiments, the processor 701 may include any suitable hardware processor, such as a microprocessor, a micro-controller, a central processing unit (CPU), a graphic processing unit (GPU), a network processor (NP), a digital signal processor (DSP), an application specific integrated circuit (ASIC), a field-programmable gate array (FPGA), or another programmable logic device, discrete gate or transistor logic device, discrete hardware component. In some embodiments, the memory 702 may include a non-transitory computer-readable storage medium, such as a random access memory (RAM), a read only memory, a flash memory, a hard disk storage, or an optical medium.

In some embodiments, the instructions stored in the memory, when executed by the processor, may cause the processor to determine an upsample region of an image.

The image may include at least one of a Bayer image or a red-green-blue (RGB) image. In a Bayer image, each pixel can record one of the three primary colors—red, green, and blue. Usually, approximately 50% of the pixels in the Bayer image are green, approximately 25% of the pixels are red, and approximately 25% of the pixels are blue. In an RGB image, each pixel includes three sub-pixels. The three sub-pixels correspond to red, green, and blue color components, respectively.

In some embodiments, the instructions may further cause the processor to perform an upsampling operation in the upsample region.

With the upsampling operation, the number of pixels, i.e., a pixel number, is increased in the upsample region. The upsample region that has been subject to the upsampling operation may also be referred to as an upsampled upsample region.

In some embodiments, the instructions may further cause the processor to generate a target image based on the upsample region and a non-upsample region.

The non-upsample region refers to a region where no upsampling operation is performed, and hence the number of pixels in the non-upsample region remains unchanged.

The instructions can cause the processor to perform functions consistent with the disclosure, such as functions described in the method embodiments.

For details of the functions of the above-described devices or functions of the modules of a device, references can be made to method embodiments described above, descriptions of which are not repeated here.

Those of ordinary skill in the art will appreciate that the exemplary elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the exemplary methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computing device, such as a processor, a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method for image processing, comprising:
determining an upsample region based on a region excluding a region of interest (ROI) in an image; and
performing an upsampling operation in the upsample region without performing the upsampling operation in the ROI.

2. The method according to claim 1, wherein the image includes at least one of a Bayer image or a red-green-blue (RGB) image.

3. The method according to claim 2, wherein determining the upsample region includes determining a region within one or more of four border strips of the raw image as the up sample region.

4. The method according to claim 2, wherein determining the upsample region includes determining a region within a border strip of the raw image as the upsample region.

5. The method according to claim 1, further comprising:
determining a low-frequency region in the image as the upsample region.

6. The method according to claim 5, further comprising, before determining the low-frequency region in the image as the upsample region:
receiving a reference image including one or more test regions;
obtaining a gradient of each of the one or more test regions;
determining that the gradient of one of the one or more test regions is smaller than a preset value; and
determining a region in the image that corresponds to the one of the one or more test regions in the reference image as the low-frequency region.

7. The method according to claim 6, further comprising:
receiving a first image frame of a video,
wherein:
receiving the reference image includes receiving a second image frame of the video that precedes the first image frame in the video.

8. The method according to claim 6,
wherein a test region includes one or more test sub-regions,
wherein obtaining a gradient of the test region in the reference image includes:
obtaining gradients of the one or more test sub-regions in the test region; and
averaging the gradients of the one or more test sub-regions in the test region to obtain the gradient of the test region.

9. The method according to claim 8, wherein a test sub-region has one of a rectangular shape or a circular shape.

10. The method according to claim 8,
wherein the image includes a first Bayer image, and the reference image includes a second Bayer image,
wherein obtaining the gradients of the one or more test sub-regions in the test region includes:
obtaining the gradients of the one or more test sub-regions based on pixels of a same color in the one or more test sub-regions.

11. The method according to claim 10, wherein:
the same color is one of a red color, a green color, or a blue color.

12. The method according to claim 1, wherein performing the upsampling operation in the upsample region includes performing a first directional upsampling in a first sampling direction in the upsample region.

13. The method according to claim 12, wherein performing the upsampling operation in the upsample region further includes performing a second directional upsampling in a second sampling direction in the upsample region.

14. The method according to claim 13, wherein:
performing the first directional upsampling in the first sampling direction includes performing the first directional upsampling in one of a horizontal direction or a vertical direction, and
performing the second directional upsampling in the second sampling direction includes performing the second directional upsampling in another one of the horizontal direction or the vertical direction.

15. The method according to claim 1, further comprising:
generating a target image based on the ROI and the upsample region; and
outputting the target image.

16. An image processing apparatus, comprising:
a processor; and
a memory storing instructions that, when executed by the processor, cause the processor to:
determine an upsample region based on a region excluding a region of interest (ROI) in an image; and
perform an upsampling operation in the upsample region without performing the upsampling operation in the ROI.

17. The apparatus according to claim 16, wherein the image includes at least one of a Bayer image or a red-green-blue (RGB) image.

18. The apparatus according to claim 17, wherein the instructions further cause the processor to determine a region within a border strip of the raw image as the upsample region.

19. The apparatus according to claim 17, wherein the instructions further cause the processor to determine a region within one or more of four border strips of the raw image as the up sample region.

20. The apparatus according to claim 16, wherein the instructions further cause the processor to determine a low-frequency region in the image as the upsample region.
